(19) United States
(12) Patent Application Publication
(10) Pub. No.: US 2026/0034564 A1
(43) Pub. Date: Feb. 5, 2026

(54) Trench Spoils Screening System

(71) Applicant: Randy M. Putnam, Redmond, OR (US)

(72) Inventor: Randy M. Putnam, Redmond, OR (US)

(21) Appl. No.: 19/287,746

(22) Filed: Jul. 31, 2025

Related U.S. Application Data
(60) Provisional application No. 63/677,760, filed on Jul. 31, 2024.

(51) Int. Cl. B07B 1/22

(52) U.S. Cl. CPC B07B 1/22

(57) ABSTRACT

A trench spoils screening device is provided for coupling with a digging machine to sift soil removed from the ground by the digging machine. A rotating hopper on a sliding frame has openings in the sidewall of the hopper for passing soil of different sizes therethrough. The soil passing through the openings forms one or a plurality of soil paths. When employed to sift soil from a trench, the finest soil is positioned closest to the trench and progressively coarser soil and rocks are positioned in pathways further from the trench.

### BACKGROUND OF THE INVENTION

### 1. Field of the Invention

The invention herein disclosed relates generally to excavation such as in the field of trenching by an excavator. More particularly it relates to a device configured to continuously follow an excavator which sifts excavated material and positions it adjacent to the formed trench.

### 2. Prior Art

### BACKGROUND OF THE INVENTION

In modern construction trenching employs mechanized equipment or a trenching machine to form an elongated narrow trench which extends below the surface of the ground. Such is conventionally accomplished using earthmoving machinery, such as an excavator or a trencher. In conventional construction, such trenches are formed to position the infrastructure, such as water and gas supply lines and electrical supply lines below grade. To that end, trenches are formed conventionally to be deeper than they are wide, as opposed to a ditch, and more narrow compared to their length, as opposed to a hole or pit.

During the process of trenching, soil is removed from the trench and the trench is left open for the positioning of the various pipes, supply lines, and wiring therein.

Conventionally, during the process of forming the trench along the desired alignment in the soil, excavating contractors will move the soil excavated from the trench to a site remote the trench for storage and eventual processing to remove large stones and otherwise reformat the excavated soil to meet the requirements for a repositioning in a backfilling of the trench when required.

This process thus requires the trenching contractor to dig soil from the trench and then position it for removal to the chosen remote site by a dump truck or other soil carrying machinery. At the remote site, the soil is conventionally processed first to remove large rocks. Once the larger rocks have been removed, the repositioned soil is conventionally sifted or otherwise processed to remove smaller rocks and courser soil to form backfill material suitable to meet the requirements for backfilling the trench once the utilities are installed therein.

With the repositioned soils having been processed, as noted, the soil is then repositioned by a dump truck or similar dirt hauling machinery back to a position adjacent the trench. Thereafter, workers or machinery or both will backfill the trench with the processed soil. As can be discerned, such repositioning of excavated soil to remote positions and back to positions adjacent the trench, and the required sifting and separation, is both labor intensive and expensive.

With respect to the above, before explaining at least one preferred embodiment of the trench spoils screening system herein, it is to be understood that the disclosed device and system herein is not limited in its application to the details of employment and to any arrangement of steps set forth in the following description or illustrated in the drawings. The various soil screening apparatus and components and configurations and methods of employment thereof as herein disclosed, are capable of other equivalent embodiments, and of being practiced and carried out in various ways, all of which will be obvious to those skilled in the art subsequent to their review of this specification.

Also, it is to be understood that the phraseology and terminology employed herein are for the purpose of description for an understanding of the use and operation of the trench spoils screening system herein and should not be regarded as limiting. As such, those skilled in the art will appreciate that the conception upon which this disclosure is based may readily be utilized as a basis for other soil screening devices and systems adapted for use in combination with trenching machinery. It is important, therefore, that the embodiments, objects and claims herein, be regarded as including such equivalent construction and methodology insofar as they do not depart from the spirit and scope of the present invention.

### SUMMARY OF THE INVENTION

The spoils screening apparatus and method herein is adapted for employment in concert with a trenching machine such as a backhoe or an excavator, or other machinery configured to form trenches in soil wherein soil spoils are generated from the soil removed to form the trench. Such soil spoils for example can include fine soil, course soil, and rocks and stones when excavated.

In all configurations of the device herein, the soil screening or sifting components are operatively engaged to a frame. The base at the lower end of the frame, which is positioned adjacent the soil during employment of the device, is configured to traverse over the soil adjacent a trench during formation of the trench by trenching machinery, such as a backhoe or an excavator or other machinery configured and operating to form trenches. Currently, the base includes skids which are positioned on the lower end of the frame and the skids slide upon the soil adjacent the formed trench. However, wheels or treads or other configurations may be employed as a base to slide the frame along during use and such are anticipated within the scope of this application.

In a current mode of the spoils screening device herein, power to urge the frame of the device along a path adjacent a trench being formed by a trenching digging machine is provided by the trenching machine forming trench. In this preferred mode, the soil spoils screening device is coupled to the trench digging machine, such as with a tether is engaged between the trenching machine forming the trench and the frame. In this manner of movement, as the trenching machine digs the trench and moves along a line adjacent the trench being formed, the trench spoils screening device herein, is pulled by the tether such as a chain or cable or rope or strap, which is connected between the trenching machine and a component such as the frame of the spoils screening device herein.

The length of the tether is preferably adjustable to provide for a spacing adjustment of the coupling between the soils screening device and the trenching machine being used to form the trench. This coupling of the spoils screening device and the trenching machine provides an ability to adjust the spacing therebetween. Such is preferable as it allows the trench spoils screening device herein to be employed with multiple different pieces of trenching machines which may have differing configurations.

For example only and not to be limiting, a backhoe of one size may have a digging arm of one length whereas a backhoe of a larger size and ability may have a longer bending digging arm engaged to the digging bucket. In operation, the distance between the spoils screening device herein and the trenching machine or equipment digging the trench can thus be adjusted to an operative space by lengthening or shortening the distance of the tether and its respective connections to the frame and the trenching machine.

The soil screening device herein in self powered mode may include wheels or treads powered by motors such as electric or fueled to move the soil screening device along in concert with movement of the ditch digging machine. Such may be provided by electric or hydraulic motors which would power wheels or treads or the like to move the frame and the soil screening device along a speed to maintain the proper distance between the trench digging machinery and the soil screening device. This self powered configuration may require communication of electric current and/or hydraulic pressure along lines extending between the ditch digging machinery and the soil screening device herein in a conventional fashion. However, the simple version of the soil screening device herein and coupling to the trench digging machine using a tether is fully operational by simply being towed.

Moving in concert with the movement of the trenching machine or machinery being employed to dig the trench, the soil screening device herein will operate in combination with the trenching machine to process and reposition removed soil thereby eliminating the conventional process of relocating it multiple times.

In operation, operating in combination with the trenching machine, the screening device herein is configured with a hopper which is properly spaced from the bucket or discharge of the trenching machine, such as by adjusting the tether length, to receive the soil from the shovel or bucket which is being removed to form the trench. Where the trenching machine employs a bucket at the end of a powered digging arm, the soil removed by the bucket is deposited into the hopper by the operator. The hopper has a hopper opening located at the upper end of the frame of the device and a hopper passage which communicates soil to a discharge end of the hopper.

Operatively engaged to the frame of the device is a cylindrical drum. A first opening at an upper end of this cylindrical drum is located in the engagement on the frame to receive the soil exiting the discharge end of the hopper. The cylindrical drum is in a rotational coupling to the frame and rotates using the power of a motor operatively engaged with the drum, such as by a belt or chain or frictional contact of a drive wheel against the drum.

When electrically powered, power for an electric motor may be supplied by an onboard battery or, as noted, by an electric connection to an electric power source on the trenching machine. Where the motor rotating the drum is hydraulic, power may be provided by an electric motor driving a pump mounted on the frame, or by a conduit engaged with a hydraulic power source on the trenching machine. Alternatively, the motor may be gas or diesel powered. In either fashion, the motor operatively coupled to the drum will rotate the drum during operation of the spoils screening device.

Operation of the drum to a powered rotation can be ongoing, or more preferably to save electric power or fuel, powered rotation may be triggered by movement of the digging machine or the deposit and presence of soil in the hopper. A switch triggered by sensed weight within the hopper may close a circuit to initiate a rotation of the drum by the motor. The switch may be a weight sensing component operatively engaged with the hopper.

Optionally, a vibrating component, such as a vibrator may be operatively coupled to the hopper. Such a vibrating component may also be activated to vibrate by the electric or electronic switch sensing weight in the hopper. This vibration, communicated to the surface of the hopper, helps to prevent soil from sticking to the wall of the hopper.

The elongated tubular drum rotates in an operative coupling to the frame. By operative coupling is meant any bearing or similar support which supports the weight of the hopper and any soil therein during rotation. The drum is coupled to the frame in a substantially angled vertical position locating the first opening to the interior cavity of the drum, at an elevated position relative to a second opening on the drum at a lower elevation. This angled positioning allows gravity to draw the soil deposited into the first opening from the hopper downward and toward the second opening.

Currently, the axis of the rotating drum, in such a vertical positioning relative to the ground on which the device is positioned, runs at an angle between 20-50 degrees. An angle of substantially 25-35 degrees has been shown in experimentation to provide excellent movement of the soil therethrough and proper screening results of the soil. This angled positioning and the rotation of the drum insures the largest soil particles, such as rocks and clods and the like of remainder soil, too large to fit through openings in the sidewall of the drum, fall out the exit opening of the drum at a lower second end thereof.

A sifting of the soil during travel through the interior cavity of the rotating drum is provided by openings formed in the sidewall of the drum. These openings are sized to allow soil and particulate smaller than the size of the openings to fall through through the openings in the upward angled drum. Rocks, stones, and soil clumps and the like, which are larger than the formed openings through the sidewall, will not pass therethrough. These rocks and large pieces of soil will be ejected from the second opening at the lower end of the drum thereby forming a rock path as the soil screening device moves along with the digging machine.

The openings formed in the sidewall of the drum may be formed in a single size, or in one preferred mode of the soil screening device herein, annular sections of the surrounding sidewall of the drum can include openings formed in two or more different sized sets of such openings. This configuration will allow the set of smaller openings to pass soil which is sized to communicate therethrough to be deposited in a third path of soil adjacent the trench.

In operation of the soil screening device, soil pieces and rocks, which are larger than the size of the first set of openings, will be rejected and continue downward through the drum. Portions of soil and rocks smaller than an adjacent second set of openings but will pass through the second set of openings to form a second path of soil on the ground which is adjacent the first path of soil.

Rocks, clumps, stones, and soil sized larger than the size of the second set of openings which is also larger than the first set of openings, will be ejected from the second end of the drum onto the ground to a path or positions adjacent but away from the first pathway and second pathway of sifted soil. Currently, one preferred size of the openings is formed to be 1-2 inches wide, such as in between side bars spaced apart that distance. A second larger size of the openings in the second annular area formed around the sidewall of the drum are formed in a range of 3-5 inches in size. However, it should be noted that the size of the openings may vary depending on the work being done and the trench being dug. As such, it may be customized to reject passage of soil particles of one size, while passing those of another size as needed. Further, there may be at least one size of the openings formed in the sidewall or a plurality of different sized openings formed into the sidewall of the drum in adjacent sections of the sidewall of the drum.

Once digging of a length of trench is complete, the rocks and larger soil clumps being positioned along the first pathway spaced away from the sifted soil may be hauled away. The sifted soil, be it in one path of a single siz, or along two paths of differing sizes, can then be pushed or otherwise deposited easily back into the adjacent trench.

Where two sized openings are employed in sections of the sidewall of the drum, as the screening device moves along with the digging machine, it positions the path of larger soil particles farther from the trench and the one or plurality of pathways of smaller sifted soil particles closer to the trench. In operation coupled to move along in concert with a digging machine forming a trench, the soils sifting device herein thus will form different adjacent pathways of sifted soil adjacent the trench and each other. Where the different pathways of soil formed on the ground are formed of sequentially larger soil particles it allows for an easy sequential filling of the trench, when required.

Thus, upon completion of a section of trench, the soil in one pathway formed of smaller sifted sizes closest to the trench may be easily deposited to the bottom of the trench in a first layer covering pipes, cables or other components at the bottom of the trench. Using the smallest soil particles from the pathway closest to the trench will prevent damage to the pipes or cable therein. Thereafter, larger soil particles from an adjacent second soil pathway further from the trench when deposited, will not directly impact the pipes or cables already covered by the finer or smaller soil and such will prevent damage. The pathway of the largest rocks and soil pieces exiting the second end of the drum, forming a pathway furthest from the trench, may be removed from the site easily or, if used, may be easily placed at the top end of the fill for the trench.

With respect to the above summary description, before explaining at least one preferred embodiment of the trench spoils screening system herein, it is to be understood that the invention is not limited in its application to the details of operation nor the arrangement of the components or the steps set forth in the following description or illustrations in the drawings. The various methods of implementation and operation of the trench spoils screening system herein, are capable of other embodiments and of being practiced and carried out in various ways which will be obvious to those skilled in the art upon their review this disclosure. Also, it is to be understood that the phraseology and terminology employed herein are for the purpose of description and should not be regarded as limiting.

Therefore, those skilled in the art will appreciate that the conception upon which this disclosure is based may readily be utilized as a basis by others for designing of other modes for carrying out the several purposes of the present trench spoils screening system. Therefore, the objects and claims herein should be regarded as including such equivalent construction, steps, and methodology insofar as they do not depart from the spirit and scope of the present invention.

As used in the claims to describe the various inventive aspects and embodiments, “comprising” means including, but not limited to, whatever follows the word “comprising.” Thus, use of the term “comprising” indicates that the listed elements are required or mandatory, but that other elements are optional and may or may not be present. By “consisting of” is meant including, and limited to, whatever follows the phrase “consisting of.” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the

listed elements. Where used herein, if not otherwise defined, the term “substantially” means plus or minus five percent.

It is an object of this invention to provide a trench spoils soil screening device which will move in concert with the trenching machine digging a trench and continuously process soil spoils for size as they are removed from the trench while the trench is dug.

It is a further object of this invention to provide such a trench spoils soil screening device which processes the spoils for repositioning back into the trench and deposits them in linear pathways adjacent the trench. Thereby eliminating the need to transport soil spoils from the dig site and back again.

It is a further object of the invention to process the trench spoils of soil and deposit the sifted soil in one or preferably a plurality of soil pathways adjacent the trench for easy repositioning of the sifted soil back into the trench.

It is yet another object of this invention to form individual pathways of sifted soil dug from a trench in adjacent pathways to the trench where the soil with the smallest or finest pieces is deposited in a path closest to the trench, and larger sifted soil is deposited further from the trench in sequential paths on the ground formed of larger soil particles and rocks.

These together with other objects and advantages, which become subsequently apparent, reside in the details of the construction and operation of the disclosed trench spoils screening system herein as more fully hereinafter described and claimed, reference being had to the accompanying drawings forming a part thereof, wherein like numerals refer to like parts throughout.

Further objectives of this invention may be ascertained by those skilled in the art as brought out in the following part of the specification wherein detailed description is for the purpose of fully disclosing the invention without placing any limitations thereon.

### BRIEF DESCRIPTION OF DRAWING FIGURES

The accompanying drawings, which are incorporated herein and form a part of the specification, illustrate some but not the only or exclusive examples of embodiments and/or features of the disclosed trench spoils screening system and device herein. It is intended that the embodiments and figures disclosed herein are to be considered illustrative of the invention herein, rather than limiting in any fashion.

In the drawings:

FIG. 1 shows a perspective view of the spoils screening device in operative position to sift and screen trench spoils and deposit sifted soil in multiple pathways by soil size adjacent the trench.

FIG. 2 depicts the spoils screening device of FIG. 1 showing it coupled to a digging or trenching machine such as using a tethered engagement to the trenching or digging machine to thereby move in concert with it.

FIG. 3 depicts the spoils screening device showing annular sections of the sidewall of the rotating drum having differing sized openings therein which will sift soil therethrough and deposit adjacent paths of soil and ejected rock adjacent to the trench during operation.

FIG. 4 shows another view of the spoils screening device herein in coupled to a trenching machine such as an excavator, and showing the ongoing deposit soil spoils into the hopper for screening by the hopper and ejection therefrom in differing individual pathways adjacent the trench.

### DETAILED DESCRIPTION OF THE PREFERRED

### Embodiments of the Invention

In this description, the directional prepositions of up, upwardly, down, downwardly, front, back, top, upper, bottom, lower, left, right, first, second, and other such terms refer to the trench spoils screening device and system and components thereof as they are oriented and appear in the drawings and all such terms are used for convenience only and such are not intended to be limiting or to imply that the trench spoils screening device has to be used or positioned in any particular orientation.

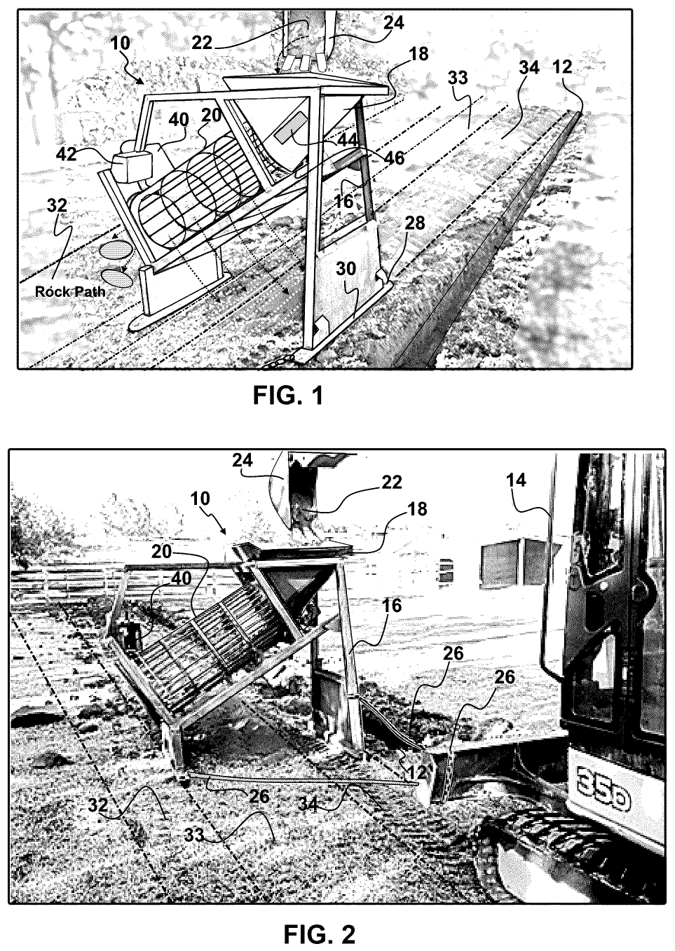

Now referring to drawings in FIGS. 1-4, there is seen in FIGS. 1-2 a perspective view of the spoils screening device 10 as it will be situated adjacent a trench 12 being dug by a trenching machine 14. As shown, the device 10 has a frame 16 to which is coupled a hopper 18 and which is operatively coupled with a rotatable drum 20.

As noted, the hopper 18 has an opening at a first end positioned to receive excavated soil 22 from a depositing component of the trenching machine 14, such as a bucket 24 found on backhoes and excavators. However, other trenching machines 14, as would occur to those in the art, are anticipated where such trenching machines 14 are powered to move on the ground and can be tethered to the spoils screening device 10 to pull it along to work in concert with the trenching machine 14. As noted, the device 10 may be configured with powered wheels or powered treads to self power movement. However, a tether 26 for operative coupling to the trenching machine 14 provides for movement of the device 10 in concert and with proper spacing from the trenching machine 14 as the trench is dug.

As shown in FIGS. 1-2, the device 10 has a tether 26 engaged between the device 10 such as with the frame 16 and the powered trenching machine 14. The tether 26 is preferably adjustable in length so as to allow for a spaced positioning of the device 10 and the hopper 18 in a location which allows continuous deposit of excavated soil 22 into the hopper 18 even as the device 10 and trenching machine 14 move along and form the trench 16.

The frame 16 has a base 28 which contacts against the ground during movement of the frame 16 and device 10 when pulled by the trenching machine 14. The base 28 may be configured with skids 30 in a simple mode of the device 10 wherein the skids 30 slide on the ground during movement, or in other modes, it may be wheeled or have tracks or the like (well know but not shown). Currently, two parallel skids 30 provide a staple position and substantially straight sliding of the device 10 during pulling by the trenching machine 14. This stable and straight travel is preferred so that sifted soil from the drum 20 is deposited in straight paths adjacent the trench 12.

In FIGS. 1-3 are shown multiple pathways wherein sifted soil is deposited to the ground adjacent the trench 12 by the device 10 during the formation of the trench 12. The device 10 will deposit sifted soil to the ground in at least two individual spaced pathways where larger soil components such as rocks and large soil clumps are ejected furthest from the trench from the drum 20 along a third pathway. Finer sifted soil is sifted through openings in annular sections of the sidewall of the drum 20 and deposited from the drum 20 in at least a second pathway 33. However, in one preferred mode of the device 10, a third pathway 34 of the soil having the smallest particles is deposited along the third pathway closest to the trench 12.

This separated pathway depositing of the excavated soil 22 on the ground is accomplished by the formation of annular sections of the sidewall of the drum 20 where each annular section has openings formed therein of differing sizes. While, as noted, the openings may all be of one size and thereby deposit a single path of sifted soil on the ground, it is preferred that at least two differing size openings are formed into the sidewall of the drum 20.

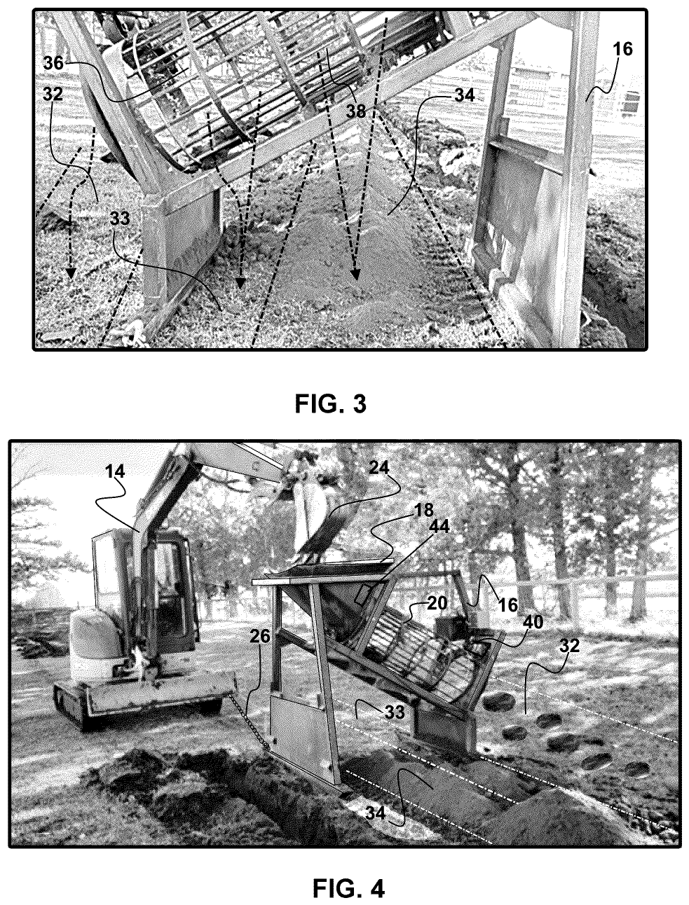

As can be seen in FIGS. 1 and 3, the drum 20 is in a rotating coupling to the frame 16 and has openings formed in two annular sections. A first annular section of the sidewall has a first size of openings 36 and a second annular section of the sidewall has a second size of openings 38 therein. The second size of openings 38 are smaller than the first size of openings 36. This results in smaller soil particles passing through the second sized openings 38 and larger sized soil particles being passed through the first size openings 36, since they could not pass through the second sized openings 38.

During operation of the device 10, while being pulled or otherwise traveling at a fixed distance from a trenching machine 14, soil spoils or excavated soil 22 from the trench which are removed by the trenching machine is deposited to a first end of the hopper 18. The deposited excavated soil 22 is communicated from the hopper 18 to an exit at a second end opposite the first end of the hopper and into a first end of the rotating drum 20.

During rotation of the drum 20 rocks and large soil particles too large to pass through either of the formed first sized openings 36 and second sized openings 38 in the annular sections thereof in the sidewall of the drum 20, will exit the lower end drum 20 and onto the ground in the pathway 32 of remainder soil preferably furthest from the trench 12.

Where two or more different sized openings are formed into different adjacent annular sections of the drum 20, soil particles too large to pass through the second openings 38 in the drum 20, but small enough to pass through the first openings 36, will communicate through the first openings 36 and form a second pathway 33 of soil on the ground adjacent to but spaced from the first pathway.

Where at least two different sized openings are formed into the sidewall of the drum 20, soil particles small and fine enough to pass through the second sized openings 38 in the drum 20 will flow through such and will be deposited on the ground closest to the trench 12 in the third pathway 34 of sifted soil.

Depositing the soil having the smallest size particles in a third pathway adjacent the trench 12 allows it to be easily pushed into the trench 12 upon cessation of digging once the pipes or cables or other buried infrastructure are positioned in the bottom of the trench 12. Positioning the soil with larger particles which passed through the first sized openings 36 in the drum 24 in the second pathway 33 adjacent the third pathway 34, allows the sifted soil with larger particles to be easily pushed into the trench 12 once the soil from the third pathway 34 has been first deposited therein.

Finally, positioning the unwanted rocks and largest soil particles in the first pathway 32 furthest from the trench 12 and adjacent the second end of the frame and second end of the drum 20, allows them to be gathered and removed easily, even if the device 10 is still positioned adjacent to the trench 12.

As noted above, a motor 40 is operatively coupled to the rotatable drum 20, such as with a chain or belt or tire and provides powered rotation to the drum 20 while excavated soil 22 is processed through the drum 20. Power for the motor 40 may be provided by an onboard battery 42 or solar panels, or an electric connection to a generator on the trenching machine 14. Alternatively, as noted, the motor 40 may be hydraulicly driven with pressurized hydraulic fluid communicated from a pump on the trenching machine 14.

As also noted, to keep the excavated soil 22 deposited into the internal cavity of the hopper 18 from sticking to it, a vibrator 44 may be operatively engaged to the hopper 18. Power to the vibrator 44 may be electric from the same sources as the motor 40. To save electric power when the device 10 is not receiving excavated soil 22 from the discharge component, such as the bucket 24 of the trenching machine 14, a weight sensing switch 46 may be operatively positioned to sense the weight of soil in the hopper wherein it will close and connect electric or hydraulic power to the motor 40. Where no or a minimum weight is sensed from soil in the hopper 44 the switch 46 will open any electric connection and the motor 40 will cease operation and drawing power from the source powering it.

While all of the fundamental characteristics and features of the disclosed trench spoils screening device and system herein, have been shown herein, with reference to particular embodiments thereof, a latitude of modification, various changes and substitutions are intended in the foregoing disclosure. It will be apparent that in some instances, some features of the disclosed spoils screening invention may be employed without a corresponding use of other features without departing from the scope of the invention as set forth.

It should also be understood that various substitutions, modifications, and variations may be made by those skilled in the art, upon viewing this disclosure without departing from the spirit or scope of the invention. Consequently, all such modifications and variations and substitutions are considered included within the scope of the invention as defined by the following claims.

What is claimed is:

1. A trench spoils screening apparatus comprising:
a frame having a lower end positioned below an upper end thereof;
said lower end configured for supporting said frame upon the ground;
a hopper coupled at said upper end of said frame;
said hopper having a first opening at a first end thereof, said first opening configured for deposit of soil from a digging machine forming a trench therein;
said hopper having a second opening at a second end;
a drum, said drum rotationally coupled to said frame;
a motor coupled to said drum imparting a rotation to said drum;
said drum having a sidewall surrounding an interior cavity, said sidewall communicating between a first drum opening and an opposite second drum opening;
said first drum opening positioned for receiving said soil exiting said hopper from said second opening of said hopper;
a first set of openings communicating through said sidewall, said first set of openings formed in a first section of said sidewall of said drum;
said first set of openings sized for passing a first portion of said soil therethrough to form a second pathway of said soil upon said ground;
said second drum opening positioned for depositing a remainder portion of said soil not communicated to said second pathway, into a first pathway upon ground; and
said first set of openings located to form said second pathway positioned closer to said trench than said first pathway.

2. The trench spoils screening apparatus of claim 1, additionally comprising:
said second drum opening positioned at an elevation above said ground which is lower than said first drum opening.

3. The trench spoils screening apparatus of claim 1, additionally comprising:
said drum rotationally coupled to said frame to rotate around said axis thereof which is an angle to said ground between 20-50 degrees.

4. The trench spoils screening apparatus of claim 2, additionally comprising:
said drum rotationally coupled to said frame to rotate around said axis thereof which is an angle to said ground between 20-50 degrees.

5. The trench spoils screening apparatus of claim 1, additionally comprising:
a second set of openings communicating through said sidewall, said second set of openings formed in a second section of said sidewall of said drum in between said first drum opening and said first set of openings;
said second set of openings sized smaller than said first set of openings, said second set of openings for passing a second portion of said soil therethrough to form a third pathway of said soil upon said ground; and
said third pathway being positioned on said ground closer to said trench than said second pathway.

6. The trench spoils screening apparatus of claim 2, additionally comprising:
a second set of openings communicating through said sidewall, said second set of openings formed in a second section of said sidewall of said drum in between said first drum opening and said first set of openings;
said second set of openings sized smaller than said first set of openings, said second set of openings for passing a second portion of said soil therethrough to form a third pathway of said soil upon said ground; and
said third pathway being positioned on said ground closer to said trench than said second pathway.

7. The trench spoils screening apparatus of claim 4, additionally comprising:
a second set of openings communicating through said sidewall, said second set of openings formed in a second section of said sidewall of said drum in between said first drum opening and said first set of openings;
said second set of openings sized smaller than said first set of openings, said second set of openings for passing a second portion of said soil therethrough to form a third pathway of said soil upon said ground; and
said third pathway being positioned on said ground closer to said trench than said second pathway.

8. The trench spoils screening apparatus of claim 4, additionally comprising:
a second set of openings communicating through said sidewall, said second set of openings formed in a second section of said sidewall of said drum in between said first drum opening and said first set of openings;
said second set of openings sized smaller than said first set of openings, said second set of openings for passing a second portion of said soil therethrough to form a third pathway of said soil upon said ground; and
said third pathway being positioned on said ground closer to said trench than said second pathway.

9. The trench spoils screening apparatus of claim 1, additionally comprising:
a tether having a first end thereof and a second end thereof;
said first end of said tether being coupled to said frame; and
said second end of said tether for coupling to said digging machine whereby said frame can be pulled by movement of said digging machine to move in concert therewith at a constant distance therefrom.

10. The trench spoils screening apparatus of claim 9, additionally comprising:
skids coupled to said lower end of said frame, said skids for supporting said frame upon the ground.

11. The trench spoils screening apparatus of claim 10, additionally comprising:
a vibrator coupled to said hopper.

12. The trench spoils screening apparatus of claim 11, additionally comprising:
a weight sensing switch, said weight sensing switch ceasing said imparting rotation to said drum by said motor when said soil is not within said hopper.
